(19) United States
(12) Patent Application Publication
(10) Pub. No.: US 2026/0191198 A1
(43) Pub. Date: Jul. 9, 2026

(54) HERBICIDAL COMPOSITION COMPRISING THIENCARBAZONE AND FLUROXYPYR

(71) Applicant: ADAMA AGAN LTD., Ashdod (IL)

(72) Inventors: Nir GANONYAN, Modi'in (IL); David MOCATTA, Gedera (IL)

(73) Assignee: ADAMA AGAN LTD., Ashdod (IL)

(21) Appl. No.: 18/868,436

(22) PCT Filed: May 22, 2023
(86) PCT No.: PCT/IL2023/050521

§ 371 Date: Nov. 22, 2024

Related U.S. Application Data
(60) Provisional application No. 63/344,655, filed on May 23, 2022.

(51) Int. Cl. A01N 43/653; A01N 25/04; A01N 25/30; A01N 43/40

(52) U.S. Cl. CPC A01N 43/653; A01N 25/04; A01N 25/30; A01N 43/40

(57) ABSTRACT

The present invention provides an herbicidal composition comprising thiencarbazone-methyl, fluroxypyr-meptyl, a safener, an inert system and agrochemically acceptable carriers; wherein thiencarbazone-methyl is present in an amount of 0.25 to 1.50% w/w; fluroxypyr-meptyl is present in amount 7.2 to 38% w/w; safener is present in an amount 1.5 to 9% w/w and the inert system comprises at least a surfactant, an adjuvant or a combination thereof.

### FIELD OF THE INVENTION

The present invention relates to an herbicidal composition comprising thiencarbazone-methyl, fluroxypyr-meptyl, a safener, an inert system and agrochemically acceptable carriers; wherein thiencarbazone-methyl is present in an amount of 0.25 to 1.50% w/w; fluroxypyr-meptyl is present in amount of 7.2 to 38% w/w; safener is present in an amount of 1.5 to 9% w/w and the inert system comprises at least a surfactant, an adjuvant or a combination thereof.

### BACKGROUND OF THE INVENTION

Oil dispersions (OD) are dispersions of active material in a non-aqueous phase intended for dilution before use. Oil dispersions are preferred over other agrochemical formulations as the active ingredient when formulated in an oil base provides better penetration through the leaf surface. The actives applied in the form of an oil dispersion do not get washed off with rainfall and retained for longer periods on the leaf surface.

However, oil dispersion formulation comprising thiencarbazone-methyl and fluroxypyr-meptyl in the field of agrochemicals is not known. When the present inventors tried to formulate an oil dispersion formulation comprising thiencarbazone-methyl and fluroxypyr-meptyl they met with several challenges in formulation such as stability issues, settling, sedimentation, caking, loading. The most common and difficult part in an oil dispersion formulation is the non-availability of a uniform suspension of the active throughout the formulation. As a result, the actives cannot be applied uniformly over the crop.

WO2005051082A1 patent application discloses oil suspension concentrate composition containing one or more types of herbicidal active compounds from the group of thienyl-sulphonamide and one or more organic solvents. However, this patent application does not disclose any example of the combination of thiencarbazone-methyl, fluroxypyr-meptyl and safener.

The inventors of the present invention overcame the associated problems and succeeded in formulating an oil dispersion formulation. The formulation of the present invention not only eliminates the associated drawbacks as noted in the preceding paragraph but also provides a superior composition which is otherwise difficult to achieve in a cost-effective manner.

The inventors of the present invention have formulated a stable oil dispersion formulation wherein thiencarbazone-methyl, fluroxypyr-meptyl, a safener, an inert system and agrochemically acceptable carriers are present in the defined concentration.

Surprisingly, the inventors of the present application have determined that the oil dispersion formulation exhibits excellent biological effectiveness in terms of yield, plant growth, and crop protection. Moreover, the composition of the present invention also exhibits superior physical characteristics such as suspensibility, stability, pourability, improved viscosity and is easy to apply and use. The compositions of the present invention also demonstrate superior performance under accelerated storage. Surprisingly, the oil dispersion of the present invention exhibits little or no settling during prolonged storage, it easily forms a re-suspension if agitated and exhibits little or no separation of the oily phase when diluted with water.

Thus, it is an object of the present invention to provide a stable herbicidal composition comprising thiencarbazone-methyl, fluroxypyr-meptyl, safener, an inert system and agrochemically acceptable carriers for controlling weeds.

### SUMMARY OF THE INVENTION

An herbicidal composition comprising thiencarbazone-methyl, fluroxypyr-meptyl, a safener, an inert system and agrochemically acceptable carriers; wherein the herbicidal composition is a non-aqueous composition selected from the group comprising an oil dispersion formulation and an emulsifiable concentrate formulation.

In an aspect, the present invention provides an herbicidal composition comprising thiencarbazone-methyl, fluroxypyr-meptyl, a safener, an inert system and agrochemically acceptable carriers, wherein thiencarbazone-methyl is present in an amount of 0.25 to 1.50% w/w; fluroxypyr-meptyl is present in amount of 7.2 to 38% w/w; safener is present in an amount of 1.5 to 9% w/w, wherein the inert system comprises at least a surfactant, an adjuvant or a combination thereof.

In a further aspect, the present invention provides an herbicidal composition comprising thiencarbazone-methyl, fluroxypyr-meptyl, a safener, an inert system and agrochemically acceptable carriers, wherein thiencarbazone-methyl is present in an amount of 0.25 to 1.00% w/w; fluroxypyr-meptyl is present in amount of 7.2 to 28.8% w/w; safener is present in an amount of 1.5 to 6% w/w, wherein the inert system comprises at least a surfactant, an adjuvant or a combination thereof.

In a preferred aspect, the present invention provides a safener is selected from the group comprising mefenpyr-diethyl, cloquintocet-mexyl, or fenchlorazole-ethyl.

In an aspect, the present invention provides an herbicidal composition comprising thiencarbazone-methyl, fluroxypyr-meptyl, mefenpyr-diethyl, an inert system and agrochemically acceptable carriers.

In a further aspect, the present invention provides an herbicidal composition comprising thiencarbazone-methyl, fluroxypyr-meptyl, cloquintocet-mexyl, an inert system and agrochemically acceptable carriers.

In another aspect, the present invention provides an herbicidal composition comprising thiencarbazone-methyl, fluroxypyr-meptyl, fenchlorazole-ethyl, an inert system and agrochemically acceptable carriers.

In an aspect, the present invention provides the thiencarbazone-methyl and fluroxypyr-meptyl in a ratio of 1:50 to 1:5.

In a preferred aspect, the present invention provides the thiencarbazone-methyl and fluroxypyr-meptyl in a ratio of 1:30 to 1:10

In a further aspect, the present invention provides the adjuvant as a built-in adjuvant, which comprises a non-ionic surfactant, an oil adjuvant or a combination thereof.

In another aspect, the adjuvant is present in an amount of 0.01 to 30%, wherein the non-ionic surfactant is present in an amount of 5 to 20%, or oil adjuvant is present in an amount of 0 to 20%.

In yet another aspect, the adjuvant is selected from the group comprising alcohol ethoxylate such as Imbentin T/150, Imbentin T/120, Imbentin T/65; sorbitan ester ethoxylate such as Tween 20; alkoxylated polyol ester such as Atplus UEP 100; polyethoxylated amine such as Genamin O 200; vegetable oil, mineral oil such as white mineral oil; C₁-C₆ mono-esters derived from vegetable oil such methyl soyate or a combination thereof.

In a further aspect, the present invention provides the surfactant is selected from the group comprising anionic, non-ionic, amphoteric and polymeric surfactant or a combination thereof and is present in an amount of 0.1 to 20% w/w.

In another aspect, the agrochemically acceptable carriers are selected from the group comprising a solvent, rheology modifier, pH modifier, or a combination thereof.

In an aspect, the present invention provides the solvent is selected from the group comprising aromatic and non-aromatic hydrocarbons, mixture of aromatic and non-aromatic hydrocarbon, halogenated aromatic and non-aromatic hydrocarbons, petroleum distillates, aromatic and non-aromatic ethers, esters, amides, mineral oil, petroleum oil, vegetable oil, animal oil or mixtures thereof and it is present in an amount of 30 to 80% w/w.

In a further aspect, the present invention provides the pH modifier is selected from the group comprising sodium or potassium carbonate, sodium or potassium hydrogen carbonate, sodium or potassium dihydrogenphosphate, disodium or dipotassium hydrogenphosphate, citric acid, malic acid, fatty acids such as lauric acid and oleic acid, fatty amines, triethanolamine or a combination thereof and it is present in an amount of 0.01 to 5.00% w/w.

In another aspect, the present invention provides the rheology modifier is selected from the group comprising natural silicate, synthetic silicates, natural polymer, synthetic polymer, natural oil, starch derivative or polysaccharide, inorganic fine powder or a combination thereof and it is present in an amount of 0.5 to 5% w/w.

In a preferred aspect, the present invention provides an herbicidal composition comprising adjuvant for controlling the broad leaved weeds or grass weeds, wherein the adjuvant present in the composition is effective at increasing effectiveness or efficacy of the herbicidal composition.

In another aspect, the present invention provides an herbicidal composition comprising adjuvant for controlling the broad leaved weeds or grass weeds, wherein the adjuvant is selected from the group comprising a non-ionic surfactant, an oil-based adjuvant or a combination thereof and it is present in an amount of 0.01 to 30%.

In a further aspect, the present invention provides an herbicidal composition comprising adjuvant for controlling the broad leaved weeds or grass weeds, wherein the adjuvant is selected from the group comprising alcohol ethoxylate; sorbitan ester ethoxylate, alkoxylated polyol ester, polyethoxylated amine, vegetable oil, C₁-C₆ mono-esters derived from vegetable oil, mineral oil, or a combination thereof.

In a preferred aspect, the present invention provides an herbicidal composition comprising adjuvant for controlling the broad leaved weeds or grass weeds, wherein the adjuvant consisting of alcohol ethoxylate, sorbitan ester ethoxylate, C₁-C₆ mono-esters derived from vegetable oil or a combination thereof.

In a most preferred aspect, the present invention provides an herbicidal composition comprising adjuvant for controlling the broad leaved weeds or grass weeds, wherein the adjuvant consisting of Imbentin T/65, Atplus UEP 100, methyl soyate and combination thereof.

In yet another aspect, the present invention provides an herbicidal composition comprising adjuvant for controlling the broad leaved weeds or grass weeds, wherein the weeds are selected from the group comprising Aventa fatua, Bassia scoparia, Setaria verticillata, Setaria viridis, Echinochloa crus-galli, Setaria pumila, Lolium persicum, Galium aparine L., Malva rotundifolia, Linum usitatissimum, Volunteer canary, Stellaria media, Galeopsis tetrahit L., Erodium cicutarium, Fagopyrum esculentum, Bromus japonicus, Sinapis arvensis, Ailanthus altissima, Capsella bursa-pastoris, Volunteer canola, Persicaria lapathifolia, Fagopyrum esculentum, Chenopodium album, Salsola tragus, Malva pusilla and Amaranthus retroflexus.

In a preferred aspect, the present invention provides an herbicidal composition comprising adjuvant for controlling Aventa fatua, Bassia scoparia, Setaria verticillata and Amaranthus retroflexus.

In another aspect, the present invention provides an herbicidal composition comprising thiencarbazone-methyl, fluroxypyr-meptyl, a safener, an inert system and agrochemically acceptable carriers for the control of a wide variety of harmful weeds in agricultural crops.

The above aspects and other objectives will become more apparent in view of the description given below.

### DETAILED DESCRIPTION OF THE INVENTION

In describing the embodiments of the invention, specific terminology is resorted for the sake of clarity. However, it is not intended that the invention be limited to the specific terms so selected, and it is to be understood that each specific term includes all technical equivalents that operate in a similar manner to accomplish a similar purpose.

According to the invention, the term “non-aqueous” means in principle that no effective amount of water is intentionally added to the composition. However, the term “non-aqueous” does not mean that a small amount of water cannot be present, for example as a result of association with a hygroscopic raw material. Thus, for the purposes of the present invention, the term “non-aqueous”means that water is present in an amount of no more than about 5% by weight, more preferably no more than about 2% by weight relative to the total weight of the composition.

As used herein, the term “oil dispersion” can be defined as a stable suspension of active ingredients in a water immiscible fluid usually intended for dilution with water before use. The oil dispersions also further include other dissolved ingredients in the formulation.

As used herein the term, “emulsifiable concentrate” refers to an optically transparent oily liquid formulation that is prepared by dissolving a certain amount of agrochemical active ingredients in an organic solvent (such as xylene, solvent oil and methylated vegetable oil), which may also contain surfactants and other additives.

It will be understood that the terminology used herein is for the purpose of describing embodiments only and is not intended to be limiting. As used in this specification, the singular forms “a”, “an” and “the” include plural referents unless the context clearly dictates otherwise. Thus, for example, the reference to “a surfactant” includes one or more such surfactants.

Unless defined otherwise, all technical and scientific terms used herein have the same meaning as commonly understood by one ordinarily skilled in the art to which the invention pertains. Although other methods and materials similar, or equivalent, to those described herein can be used in the practice of the present invention, the preferred materials and methods are described herein.

As used herein, the terms “comprises”, “comprising”, “includes”, “including”, or any other variation thereof, are intended to cover a non-exclusive inclusion, subject to any limitation explicitly indicated. For example, a composition or a method that comprises a list of elements is not necessarily limited to only those elements but may include other elements not expressly listed or inherent to such composition or method.

As used herein, the term “composition” or “formulation” can be used interchangeably, unless stated otherwise, is meant to encompass, and are not limited to, compositions or formulations containing the combination of thiencarbazone-methyl, fluroxypyr-meptyl and a safener.

As used herein, the term “agrochemically acceptable carriers” refers to substances which are commonly used to provide stability or to increase the activity profile of the composition or formulation with or without having agrochemical activity or direct effect on the undesired weeds such as solvent, rheology modifier, pH modifier.

As used herein, the term “surfactant” refers to a compound that, when dissolved in a liquid, reduces the surface tension of the liquid, which reduces the interfacial tension between two liquids, or which reduces surface tension between a liquid and a solid.

As used herein, the term “adjuvant” is broadly defined as any substance that itself is not an active ingredient, but which enhances or is intended to enhance the effectiveness of the agrochemical active compounds with which it is used. Adjuvants may be understood to include, but are not limited to, spreading agents, penetrants, rain fastening agents, compatibility agents, and drift retardants. They are typically used to dilute ready mix formulations prior to application in the field, although some formulations include built-in adjuvants.

As used herein, the term “thickener” refers to a polymeric or colloidal material, which at a low concentration increases the viscosity of an aqueous or oil solution and helps to stabilize the composition.

As used herein, the term, % w/w refers to % of the weight of the respective component with respect to the total weight of the composition. It is further understood that where a parameter range is provided, all integers within that range, and tenths thereof, are also provided by the subject matter. For example, “0.1% to 50%” includes 0.1%, 0.2%, 0.3%, 0.4% etc. up to 50%.

As used herein, the term “thiencarbazone” encompasses thiencarbazone or its agrochemically acceptable salt, ester such as thiencarbazone-methyl, derivative or any other modified form of thiencarbazone.

As used herein, the term “fluroxypyr” encompasses fluroxypyr or its agrochemically acceptable salt, ester such as fluroxypyr-meptyl, derivative or any other modified form of fluroxypyr.

As used herein, the term herbicide or herbicidal refers to an active ingredient that kills, controls or otherwise adversely modifies the growth of plants. Herbicidally effective or vegetation controlling amount is an amount of one or more active ingredient which causes an adversely modifying effect and includes deviations from natural development, killing, regulation, desiccation, retardation and the like.

As used herein, the term “synergistic” refers to an interaction of two or more factors such that the effect when combined is greater than the predicted effect based on the response to each other when applied individually.

Accordingly, the present invention provides an herbicidal composition comprising thiencarbazone-methyl, fluroxypyr-meptyl, a safener, an inert system and agrochemically acceptable carriers.

In an embodiment, the present invention provides a non-aqueous composition selected from the group comprising an oil dispersion formulation and an emulsifiable concentrate formulation.

Safener is an organic compound which in some cases leads to better crop plant compatibility when applied jointly with specifically acting herbicides. Some safeners are herbicidally active. In these cases, the safeners act as antidote or antagonist to the crop plants and thus reduce or even prevent damage to the crop plants.

In an embodiment of the present invention, the composition contains at least one safener in an effective amount, which is present in an amount of 1 to 10% w/w and preferably present in an amount of 1.5 to 9% w/w and more preferably present in an amount of 1.5 to 6% w/w.

Safeners include benoxacor, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, metcamifen, mefenpyr, mephenate, naphthalic anhydride, R-29148, AD-67 and oxabetrinil, as well as the agriculturally acceptable salts thereof and, provided they have a carboxyl group, their agriculturally acceptable derivatives, in particular their esters like mefenpyr as mefenpyr-diethyl, cloquintocet as cloquintocet-mexyl.

In a preferred embodiment the safener is selected from the group comprising mefenpyr-diethyl, cloquintocet-mexyl or fenchlorazole-ethyl.

In an embodiment, the present invention provides an herbicidal composition comprising thiencarbazone-methyl, fluroxypyr-meptyl, mefenpyr-diethyl, an inert system and agrochemically acceptable carriers.

In a further embodiment, the present invention provides an herbicidal composition comprising thiencarbazone-methyl, fluroxypyr-meptyl, cloquintocet-mexyl, an inert system and agrochemically acceptable carriers.

In another embodiment, the present invention provides an herbicidal composition comprising thiencarbazone-methyl, fluroxypyr-meptyl, fenchlorazole-ethyl, an inert system and agrochemically acceptable carriers.

In yet another embodiment, the present invention provides an herbicidal composition comprising thiencarbazone-methyl, fluroxypyr-meptyl, a safener, optionally, one or more herbicidal/insecticidal/fungicidal/acaricidal/nematicidal compounds or any combination thereof, an inert system and agrochemically acceptable carriers.

In an embodiment, the present invention provides an herbicidal composition comprising thiencarbazone-methyl is present in an amount of 0.25 to 1.50% w/w; fluroxypyr-meptyl is present in amount of 7.2 to 38% w/w; safener is present in an amount of 1.5 to 9% w/w, an inert system and agrochemically acceptable carriers.

In a further embodiment, the present invention provides an herbicidal composition comprising thiencarbazone-methyl is present in an amount of 0.25 to 1.00% w/w; fluroxypyr-meptyl is present in amount of 7.2 to 28.8% w/w; safener is present in an amount of 1.5 to 6% w/w, an inert system and agrochemically acceptable carriers.

In another embodiment, the present invention provides an herbicidal composition comprising thiencarbazone-methyl is present in an amount of 0.40% w/w; fluroxypyr-meptyl is present in amount of 11.3% w/w; mefenpyr-diethyl is present in an amount of 2.35% w/w, an inert system and agrochemically acceptable carriers.

In a preferred embodiment, the present invention provides herbicidal composition comprising thiencarbazone-methyl and fluroxypyr-meptyl in a ratio of 1:50 to 1:5 and preferably in a ratio of 1:30 to 1:10.

In a most preferred embodiment, the present invention provides herbicidal composition comprising thiencarbazone-methyl and fluroxypyr-meptyl in a ratio of 1:25 to 1:30 and preferably in a ratio of 1:29.

In another embodiment, the present invention provides the inert system comprises at least a surfactant, an adjuvant or a combination thereof.

Surfactant (an emulsifying agent/a wetting agent/a dispersing agent) comprises anionic surfactant, non-ionic surfactant, amphoteric surfactant, polymeric surfactant or a combination thereof. It is preferred to use one or more than one kind of surfactant. Surfactants are compounds that lower the surface tension (or interfacial tension) between two liquids, between a gas and a liquid, or between a liquid and a solid.

Surfactants were added to stabilize the oil dispersion or emulsifiable concentrate formulation and improve the viscosity of the liquid phase in order to prevent the insoluble actives falling out of suspension and prevent the sedimentation in oil dispersion formulation which occurs due to aggregation and coalescence.

Surfactant is selected from the group comprising, but not limited to,
polyalkoxylated, preferably polyethoxylated, saturated and unsaturated aliphatic alcohols, having 8 to 24 carbon atoms in the alkyl radical, which is derived from the corresponding fatty acids or from petrochemical products, and having 1 to 100, preferably 2 to 50, ethylene oxide units (EO), it being possible for the free hydroxyl group to be alkoxylated, which are commercially available, for example as Genapol® X such as Genapol X 150 and Genapol® O series (Clariant), Crovol® M series (Croda) or as Lutensol® series (BASF), for example Lutensol®-A series, -AT series, -AO series, -ON series, TO series or -XL series, -Imbentin series such as Imbentin T/65, Imbentin T/150;
polyalkoxylated, preferably polyethoxylated, arylalkylphenols, such as, for example, 2,4,6-tris-(1-phenylethyl)phenol (tristyrylphenol) having an average degree of ethoxylation of between 10 and 80, preferably from 16 to 40, such as, for example Soprophor® BSU (Rhodia) or HOE S 3474 (Clariant); tristyrylphenol ethoxylate phosphate ester such as Soprophor® 3D33; polyalkoxylated, preferably polyethoxylated, alkylphenols having one or more alkyl radicals, such as, for example, nonylphenol or tri-sec-butylphenol, and a degree of ethoxylation of between 2 and 40, preferably from 4 to 15, such as, for example, Arkopal® N series or Sapogenat® T series (Clariant);
polyalkoxylated, preferably polyethoxylated, hydroxyfatty acids or glycerides which contain hydroxyfatty acids, such as, for example, ricinine or castor oil, having a degree of ethoxylation of between 10 and 80, preferably from 25 to 40, such as, for example, the Emulsogen® EL series (Clariant) or the Agnique® CSO series (Cognis), Emulsogen EL-400; polyalkoxylated, preferably polyethoxylated, sorbitan esters, such as, for example, Atplus® 309 F (Unigema); Alkamuls® series (Rhodia), Tween 20; Tween 80;
alkoxylated polyol ester such as, for example Atplus UEP 100;
polyalkoxylated, preferably polyethoxylated amine, such as, for example, Genamin® series (Clariant), for example Genamin®-C series, -O series such as Genamin O 200, -S series or -T series, Imbentin® CAM series (Kolb) or Lutensol® F series (BASF);
di- and tri-block copolymers, for example from alkylene oxides, for example from ethylene oxide and propylene oxide, having average molar masses between 200 and 10000, preferably from 1000 to 4000 g/mol, the proportion by mass of the polyethoxylated block varying between 10 and 80%, such as, for example, the Genapol® PF series (Clariant), the Pluronic© series (BASF), or the Synperonic® PE series (Unigema); Atlas™ G-5002L;
alkyl polyglucoside such as decyl glucoside; polyoxyethylene alkyl ethers such as polyoxyethylene lauryl ether, or polyoxyethylene coconut fatty alcohol ether; polyoxyethylene alkynyl ether such as polyoxyethylene 2,4,7,9-tetramethyl-5-decyn-4,7-diol ether; polyoxyethylene aryl ethers such as polyoxyethylene nonylphenyl ether or polyoxyethylene tristyrylphenyl ether; polyoxyethylene fatty acid esters such as polyoxyethylene monolaurate, polyoxyethylene distearate or polyoxyethylene resin acid ester
polyalkoxylated, preferably polyethoxylated, surfactant which are ionically modified, for example by conversion of the terminal free hydroxyl function of the polyethylene oxide block into a sulfate or phosphate ester (for example as alkali metal and alkaline earth metal salts), such as, for example, Genapol® LRO or dispersant 3618 (Clariant), Emulphor® (BASF) or Crafol® AP (Cognis);
alcohol polyglycol ether such as Ethylan NS 500 LQ®;
polyacrylate such as Dispersogen PSL 100®;
alkali metal and alkaline earth metal salts of alkylarylsulfonic acids having a straight-chain or branched alkyl chain, such as phenylsulfonate CA or phenylsulfonate CAL (Clariant), Atlox® 3377BM (ICI), or the Empiphos® TM series (Huntsman);
polyelectrolytes, such as lignosulfonates, condensates of naphthalenesulfonate and formaldehyde, polystyrenesulfonate or sulfonated unsaturated or aromatic polymers (polystyrenes, polybutadienes or polyterpenes), such as the Tamol® series (BASF), Morwet® D425 (Witco), Kraftsperse® series (Westvaco) or Borresperse® series (Borregard).
polyoxyethylene polyoxypropylene alkyl ether such as polyoxyethylene polyoxypropylene lauryl ether; polyoxyethylene polyoxypropylene aryl ether such as polyoxyethylene polyoxypropylene styrylphenyl ether; polyoxyethylene alkyl amines such as polyoxyethylene stearyl amine; polyoxyethylene fatty acid amide such as lauric acid diethanolamid; fluorinated surfactant; alkyl sulfates such as sodium lauryl sulfate; alkylbenzene sulfonate such as dodecylbenzene sulfonate calcium salt for example Nansa EVM 70/2E; phosphate ester of natural fatty alcohol such as oleyl alcohol (Croadfos 03A);
polyoxyethylene alkyl ether sulfates such as sodium polyoxyethylene lauryl ether sulfate; polyoxyethylene aryl ether sulfates such as sodium polyoxyethylene nonylphenyl ether sulfate or ammonium polyoxyethylene tristyrylphenyl ether sulfate; aryl sulfonate such as calcium dodecyl benzene sulfonate, sodium naphthalene sulfonate or sodium naphthalene sulfonate formaldehyde condensate; ‘alpha’-olefin sulfonate; alkyl sulfosuccinate such as sodium dioctyl sulfosuccinate such as Aerosol® OT-A ND; sodium lignosulfonate; polycarboxylic acid sodium salt; N-methyl fatty acid sarcosinate; polyoxyethylene alkyl ether phosphate; polyoxyethylene aryl ether phosphates such as polyoxyethylene phenyl ether phosphate; polyoxyethylene alkyl phenyl ether phosphate; graft co-polymers such as polymethyl methacrylate-polyethylene glycol graft copolymer; or a combination thereof.

Preferred surfactants are selected from the group comprising polyethylene glycol (Emulsogen EL-400), tristyryphenol (Soprophor BSU), polyalkylene glycol ether (Atlas G-5002L), polyoxyethylene sorbitan monooleate (Tween 80), alcohol polyglycol ether (Ethylan NS 500 LQ), dodecylbenzene sulfonate calcium salt (Nansa EVM 70/2E), oleyl alcohol (Crodafos O3A), tristyrylphenol ethoxylate phosphate ester (Soprophor 3D33), sodium dioctyl sulfosuccinate (Aerosol OT-A ND), polyacrylate such as Dispersogen PSL 100 or a combination thereof.

In the present invention, the surfactant is present in an amount of 0.01 to 30% w/w and preferably in an amount of 0.1 to 20% w/w.

In an embodiment, the present invention provides an adjuvant, wherein the adjuvant is commonly used to enhance the bioperformance (activity) of an agrochemical. Adjuvants can vary in complexity from simple surfactants such as non-ionic surfactants or anionic surfactants to multi component blends of oils and different surfactant types. Such adjuvant is incorporated directly in (“built-in”) to a formulation concentrate, such as an emulsifiable concentrate or an oil dispersion. Such built-in compositions are preferred by farmers because a tank-mix adjuvant is not required. This results in easier handling, especially in markets where products are sold in bulk. It may also lead to significant cost savings in manufacture because production and packaging of a separate tank-mix adjuvant is not required any more.

This ensures that the farmer will use the correct adjuvants and controls the ratio of adjuvants to agrochemical. Oil-based adjuvants are particularly useful in enhancing the bioperformance of an agrochemical. As used herein, the term “oil-based adjuvant” means a liquid adjuvant or mixture of adjuvants that is substantially insoluble in the aqueous continuous phase of the agrochemical concentrate.

The non-ionic surfactants mentioned above can also act as adjuvant. Similarly, the oil-based adjuvant includes mineral oil, petroleum oil, vegetable oil, animal oil or derivatives or mixtures thereof as mentioned above.

The examples of adjuvant system selected from but not limited to, alcohol ethoxylate such as Imbentin T/150, Imbentin T/120, Imbentin T/65; sorbitan ester ethoxylate such as Tween 20; alkoxylated polyol ester such as Atplus UEP 100; polyethoxylated amine such as Genamin O 200; vegetable oil; mineral oil such as white mineral oil; C₁-C₆ monoesters derived from vegetable oil such as methyl soyate or a combination thereof.

In an embodiment, the adjuvant system consisting of alcohol ethoxylate, sorbitan ester ethoxylate, C₁-C₆ mono-esters derived from vegetable oil and combination thereof.

In a preferred embodiment, the adjuvant system consisting of Imbentin T/65, Atplus UEP 100, methyl soyate and combination thereof.

In the present invention, the adjuvant system is present in an amount of 0.01 to 30%, wherein preferably the non-ionic surfactant is present in an amount of 5 to 20% and oil adjuvant is present in an amount of 0 to 20%.

In a preferred embodiment, the adjuvant system (non-ionic surfactant and oil) is present in an amount of 20% w/w to 22% w/w, preferably in an amount of 21.6%.

In yet another embodiment, the present invention provides the agrochemically acceptable carriers selected from the group comprising solvent, thickener, pH modifier, or a combination thereof.

Solvent is used to dissolve or suspend the additives or agrochemical compounds. It includes water immiscible solvents such as aromatic and non-aromatic hydrocarbons, or mixture of aromatic and non-aromatic hydrocarbon such as Solvesso® 100, Solvesso® 150 or Solvesso® 200, Solgad 200 ULN (heavy aromatic solvent), halogenated aromatic and non-aromatic hydrocarbons, petroleum distillates, aromatic and non-aromatic ethers, esters or amides, oils or mixtures thereof. According to further embodiment the oils can be one or more of a mineral oil, petroleum oil, vegetable oil or animal oil or derivatives or mixtures thereof. However, those skilled in the art will appreciate that it is possible to utilize other water immiscible solvents without departing from the scope of the present invention.

The mineral oil or petroleum oil can be one or more of aliphatic or isoparaffinic series, and mixtures of aromatic and aliphatic hydrocarbons; halogenated aromatic or aliphatic hydrocarbons such as white mineral oil. Paraffinic oil can be selected from linear or branched C₈ to C₃₀ paraffins for example such as octane, nonane, decane, undecane, dodecane, tridecane, tetradecane, pentadecane, hexadecane, their mixtures, or mixtures thereof with higher boiling homologs, such as heptadecane, octadecane, nonadecane, eicosane, heneicosane, docosane, tricosane, tetracosane, pentacosane, and the branched chain isomers thereof, unsubstituted or substituted aromatic or cycloaliphatic C₇ to Cis hydrocarbon compounds such as mono- or polyalkylsubstituted benzenes, or mono- or polyalkyl-substituted naphthalenes, or transesterification products thereof, liquid esters of C₁ to C₁₂ alcohols such as butanol, n-octanol, i-octanol, dodecanol, cyclopentanol, cyclohexanol, cyclooctanol, ethylene glycol or propylene glycol with C₂ to C₁₂ carboxylic or polycarboxylic acids, such as caproic acid, capric acid, caprylic acid, pelargonic acid, succinic acid and glutaric acid; or with aromatic carboxylic acids such as benzoic acid, toluic acid, salicylic acid and phthalic acid, liquid amides of C₁ to C₅ amines, alkylamines or alkanolamines with C₆ to Cis carboxylic acids, or derivatives thereof. Esters which can be used in the oil dispersions of the invention are benzyl acetate, caproic acid ethyl ester, pelargonic acid ethyl ester, benzoic acid methyl or ethyl ester, salicylic acid methyl, propyl, or butyl ester, diesters of phthalic acid with saturated aliphatic or alicyclic C₁ to C₁₂ alcohols, such as phthalic acid dimethyl ester, dibutyl ester, diisooctyl ester, or liquid amides of C₁-C₃ amines, alkylamines or alkanolamines with C₆-C₁₈ carboxylic acids or derivatives or mixtures thereof. However, those skilled in the art will appreciate that it is possible to utilize other mineral or petroleum oils without departing from the scope of the present invention.

The vegetable oils can be one or more of seed oil. The vegetable oils can also include one or more of soyabean oil, rape seed oil, olive oil, castor oil, sunflower seed oil, coconut oil, corn oil, cotton seed oil, linseed oil, palm oil, peanut oil, safflower oil, sesame oil, kapok oil, papaya oil, camellia oil, rice bran oil, tung oil and the like; and esters of the above vegetable oils, or transesterification products thereof such as soy bean oil methyl esters, ethyl esters, propyl esters, butyl esters or derivatives thereof. The animal oil can be one or more of whale oil, cod-liver oil, or mink oil. However, those skilled in the art will appreciate that it is possible to utilize other vegetable or animal oils without departing from the scope of the present invention.

The petroleum distillates include one or more of aromatic hydrocarbons derived from benzene, such as toluene, xylenes, other alkylated benzenes and the like, and naphthalene derivatives, aliphatic hydrocarbons such as hexane, octane, cyclohexane, and the like, mineral oils from the aliphatic or isoparaffinic series, and mixtures of aromatic and aliphatic hydrocarbons; halogenated aromatic or aliphatic hydrocarbons; vegetable, seed or animal oils such as soybean oil, soybean methylated oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable oils such as methyl oleate, methyl soyate, and methyl laurate, seed or animal oils; C₁-C₂₀ dialkyl amides of C₆-C₂₀ saturated and unsaturated aliphatic carboxylic acids; C₁-C₁₂ esters of aromatic carboxylic acids and dicarboxylic acids and C₁-C₁₂ esters of aliphatic and cycloaliphatic carboxylic acids; C₄-C₁₂ polyesters of dihydric, trihydric, or other lower polyalcohols such as, propylene glycol dioleate, di-octyl succinate, di-butyl adipate, di-octyl phthalate, and the like.

Solvent also include organic solvents or cosolvents such as ethers like tetrahydrofuran and the like, alkylene glycol dialkyl ethers such as ethylene glycol diethyl ether and the like, amides such as dimethylformamide, dimethylacetamide, dimethyloctaneamide, dimethyldecenamide or N-methylpyrrolidone and the like, ketones such as methyl ethyl ketone and the like, nitriles such as butyronitrile and the like, sulfoxides or sulfones such as dimethyl sulfoxide or sulfolane and the like, and alkylene carbonates such as propylene or butylene carbonate.

Preferably, the solvent is selected from the group comprising heavy aromatic solvent, methylated vegetable oil or mixtures thereof. Most preferably, the solvent is selected from the group comprising Solgad 200 ULN or methyl soyate or mixtures thereof.

In the present invention, the solvent is present in an amount of 5 to 95% w/w and preferably from 30 to 80% w/w. The solvent may be present alone or in combination.

Rheology modifiers are compounds that used to control sedimentation, also known as anti-caking agents, viscosity modifiers, thickeners, or structuring agents, generally provide the increased viscosity to the oil dispersion or emulsifiable concentrate formulation. In addition to increasing the viscosity rheology modifiers have a shear thinning capability that allows the gel network they form to easily breakdown upon application of a small external shear. This shear thinning allows the composition to maintain its viscosity and physical stability while at rest but allows this viscosity to quickly dissipate when external force is applied so that the product can be easily poured or pumped from its container, mixed in a carrier such as water and applied to an area where it is needed.

Rheology modifiers are selected from the group comprising, but not limited to, modified natural silicates, such as chemically modified bentonites, hectorites, attapulgites, montmorillonites, smectites or other silicate minerals, such as Bentone® (Elementis), Attagel® (Engelhard), Agsorb® (Oil-Dri Corporation) or Hectorite® (Akzo Nobel); synthetic silicates, such as silicates of the Sipernat®, Aerosil®, Aerosil R 812S or Durosil® series (Degussa), the CAB-O-SIL® series (Cabot) or the Van Gel series (R. T. Vanderbilt); thickeners based on natural polymers, natural oils and synthetic polymers, such as Thixin® or Thixatrol® series (Elementis), xanthan gum, welan gum, guar gum, polyvinyl alcohol, carboxymethylcellulose, polyvinylpyrrolidone, carboxyvinyl polymer, acrylic polymer, starch derivative or polysaccharide; or an inorganic fine powder selected from high purity silica, bentonite, white carbon. These thickeners may be used alone or in combination thereof.

In the present invention, the rheology modifier is present in an amount of 0.5 to 5% w/w and preferably in an amount of 1 to 3% w/w.

pH modifier is a compound that used to mix with different additives or other agrochemicals of different acidities or alkalinities. pH modifier is selected from the group comprising, but not limited to, sodium or potassium carbonate, sodium or potassium hydrogen carbonate, sodium or potassium dihydrogenphosphate, disodium or dipotassium hydrogenphosphate, citric acid, malic acid, triethanolamine, fatty acids such as lauric acid and oleic acid, fatty amines, preferably potassium carbonate. These pH modifiers may be used alone or in combination thereof.

In the present invention, the pH modifier is present in an amount of 0.01 to 5.00% w/w and preferably from 0.1 to 0.35% w/w.

In an embodiment, the present invention provides the process of preparation of oil dispersion formulation comprising thiencarbazone-methyl, fluroxypyr-meptyl, a safener, an inert system and agrochemically acceptable carriers. The thiencarbazone-methyl, fluroxypyr-meptyl, a safener, an adjuvant, were taken and stirred well with high shear in a sufficient amount of a carrier solvent. The mixture was milled by bead mill until a mean particle size i.e., D (90) of below 10 microns was obtained. Added all the other components of the oil phase and mix till homogenous. Rheology modifier is added under low stirring, following shear to ensure its dispersion, to form a homogenous oil dispersion formulation.

In another embodiment, the present invention provides the process of preparation of emulsifiable concentrate formulation comprising thiencarbazone-methyl, fluroxypyr-meptyl, a safener, an inert system and agrochemically acceptable carriers. The thiencarbazone-methyl, fluroxypyr-meptyl, a safener, were taken and stirred well in a sufficient amount of a carrier solvent and stirred continuously the active ingredients were fully dissolved. After dissolution of active ingredients emulsifier was added and continue the stirring for another 30 min. Filter the mass through filter to obtain a pesticidal emulsifiable concentrate formulation.

In a further embodiment, the present invention provides herbicidal oil dispersion or emulsifiable concentrate formulation comprising thiencarbazone-methyl, fluroxypyr-meptyl, a safener, an inert system and agrochemically acceptable carriers for the management of the weed flora.

The composition of the present invention comprising thiencarbazone-methyl, fluroxypyr-meptyl, safener can be mixed in a wide ratio, in relation to various factors such as, the weeds to be controlled, the degree of infestation, the climatic conditions, the characteristics of the soil and the application method.

In a preferred embodiment, the present invention provides an herbicidal composition comprising adjuvant for controlling the broad leaved weeds or grass weeds, wherein the adjuvant present in the composition is effective at increasing effectiveness or efficacy of the herbicidal composition.

In another embodiment, the present invention provides an herbicidal composition comprising adjuvant for controlling the broad leaved weeds or grass weeds, wherein the adjuvant is selected from the group comprising a non-ionic surfactant, an oil-based adjuvant or a combination thereof and it is present in an amount of 0.01 to 30%.

In a further embodiment, the present invention provides an herbicidal composition comprising adjuvant for controlling the broad leaved weeds or grass weeds, wherein the adjuvant is selected from the group comprising alcohol ethoxylate; sorbitan ester ethoxylate, alkoxylated polyol ester, polyethoxylated amine, vegetable oil, C₁-C₆ mono-esters derived from vegetable oil, mineral oil, or a combination thereof.

In a preferred embodiment, the present invention provides an herbicidal composition comprising adjuvant for controlling the broad leaved weeds or grass weeds, wherein the adjuvant consisting of alcohol ethoxylate, sorbitan ester ethoxylate, C₁-C₆ mono-esters derived from vegetable oil and combination thereof.

In a most preferred embodiment, the present invention provides an herbicidal composition comprising adjuvant for controlling the broad leaved weeds or grass weeds, wherein the adjuvant consisting of Imbentin T/65, Atplus UEP 100, methyl soyate and combination thereof.

In yet another embodiment, the present invention provides an herbicidal composition comprising adjuvant for controlling the broad leaved weeds or grass weeds, wherein the weeds are selected from the group comprising Aventa fatua, Bassia scoparia, Setaria verticillata, Setaria viridis, Echinochloa crus-galli, Setaria pumila, Lolium persicum, Galium aparine L., Malva rotundifolia, Linum usitatissimum, Volunteer canary, Stellaria media, Galeopsis tetrahit L., Erodium cicutarium, Fagopyrum esculentum, Bromus japonicus, Sinapis arvensis, Ailanthus altissima, Capsella bursa-pastoris, Volunteer canola, Persicaria lapathifolia, Fagopyrum esculentum, Chenopodium album, Salsola tragus, Malva pusilla and Amaranthus retroflexus.

In a preferred embodiment, the present invention provides an herbicidal composition comprising adjuvant for controlling Aventa fatua, Bassia scoparia, Setaria verticillata and Amaranthus retroflexus.

In a preferred embodiment, the herbicidal composition applied on a broad-leaved and grass weed model, i.e., during or after, the emergence of the weeds. Since this composition shows good crop tolerance.

The present invention is further illustrated by the following examples. These examples describe possible preferred embodiments for illustrative purposes only, but they do not limit the scope of the invention.

### Example 1

| S. No. | Ingredient | Function | % W/W |
|---|---|---|---|
| 1 | Fluroxypyr-meptyl | Active ingredient | 9.60% |
| 2 | Mefenpyr-diethyl | Safener | 2.00% |
| 3 | Thiencarbazone-methyl | Active ingredient | 0.33% |
| 4 | Potassium carbonate | pH modifier | 0.11% |
| 5 | Emulsogen EL-400 | Emulsifier | 5.00% |
| 6 | Nansa EVM 70/2E | Emulsifier | 0.17% |
| 7 | Dispersogen PSL 100 | Emulsifier | 1.00% |
| 8 | Aerosil R 812 S | Rheology modifier | 2.00% |
| 9 | Solvesso 200 ULN | Solvent | up to 100% |

### Example 2

| S. No. | Ingredient | Function | % W/W |
|---|---|---|---|
| 1 | Fluroxypyr-meptyl | Active ingredient | 9.60% |
| 2 | Mefenpyr-diethyl | Safener | 2.00% |
| 3 | Thiencarbazone-methyl | Active ingredient | 0.33% |
| 4 | Potassium carbonate | pH modifier | 0.11% |
| 5 | Emulsogen EL-400 | Emulsifier | 5.00% |
| 6 | Nansa EVM 70/2E | Emulsifier | 0.17% |
| 7 | Dispersogen PSL 100 | Emulsifier | 1.00% |
| 8 | Imbentin T/150 | Non-ionic surfactant Adjuvant | 15.00% |
| 9 | Aerosil R 812 S | Rheology modifier | 2.00% |
| 10 | Solvesso 200 ULN | Solvent | up to 100% |

### Example 3

| S. No. | Ingredient | Function | % W/W |
|---|---|---|---|
| 1 | Fluroxypyr-meptyl | Active Ingredient | 9.60% |
| 2 | Mefenpyr-diethyl | Safener | 2.00% |
| 3 | Thiencarbazone-methyl | Active Ingredient | 0.33% |
| 4 | Potassium carbonate | pH modifier | 0.11% |
| 5 | Emulsogen EL-400 | Emulsifier | 5.00% |
| 6 | Nansa EVM 70/2E | Emulsifier | 0.17% |
| 7 | Dispersogen PSL 100 | Emulsifier | 1.00% |
| 8 | Imbentin T/150 | Non-ionic Surfactant Adjuvant | 15.00% |
| 9 | Aerosil R 812 S | Rheology modifier | 2.00% |
| 10 | Methylated soybean oil | Co-solvent | 20.00% |
| 11 | Solvesso 200 ULN | Solvent | up to 100% |

### Example 4

| S. No. | Ingredient | Function | % W/W |
|---|---|---|---|
| 1 | Fluroxypyr-meptyl | Active Ingredient | 9.60% |
| 2 | Mefenpyr-diethyl | Safener | 2.00% |
| 3 | Thiencarbazone-methyl | Active Ingredient | 0.33% |
| 4 | Potassium carbonate | pH modifier | 0.11% |
| 5 | Emulsogen EL-400 | Emulsifier | 5.00% |
| 6 | Nansa EVM 70/2E | Emulsifier | 0.17% |
| 7 | Dispersogen PSL 100 | Emulsifier | 1.00% |
| 8 | Imbentin T/150 | Non-ionic Surfactant Adjuvant | 10.00% |
| 9 | Tween 20 | Non-ionic Surfactant Adjuvant | 10.00% |
| 10 | Aerosil R 812 S | Rheology modifier | 2.00% |
| 11 | Solvesso 200 ULN | Solvent | up to 100% |

### Example 5

| S. No. | Ingredient | Function | % W/W |
|---|---|---|---|
| 1 | Fluroxypyr-meptyl | Active Ingredient | 9.60% |
| 2 | Mefenpyr-diethyl | Safener | 2.00% |
| 3 | Thiencarbazone-methyl | Active Ingredient | 0.33% |
| 4 | Potassium carbonate | pH modifier | 0.11% |
| 5 | Emulsogen EL-400 | Emulsifier | 5.00% |
| 6 | Nansa EVM 70/2E | Emulsifier | 0.17% |
| 7 | Dispersogen PSL 100 | Emulsifier | 1.00% |
| 8 | Imbentin T/150 | Non-ionic Surfactant Adjuvant | 10.00% |
| 9 | Atplus UEP 100 | Non-ionic Surfactant Adjuvant | 10.00% |
| 10 | Aerosil R 812 S | Rheology modifier | 2.00% |
| 11 | Solvesso 200 ULN | Solvent | up to 100% |

### Example 6

| S. No. | Ingredient | Function | % W/W |
|---|---|---|---|
| 1 | Fluroxypyr-meptyl | Active Ingredient | 9.60% |
| 2 | Mefenpyr-diethyl | Safener | 2.00% |
| 3 | Thiencarbazone-methyl | Active Ingredient | 0.33% |
| 4 | Potassium carbonate | pH modifier | 0.11% |
| 5 | Soprophor BSU | Emulsifier | 1.00% |
| 6 | Nansa EVM 70/2E | Emulsifier | 0.17% |
| 7 | Dispersogen PSL 100 | Emulsifier | 1.50% |
| 8 | Atplus UEP 100 | Non-ionic Surfactant Adjuvant | 20.00% |
| 9 | Aerosil R 812 S | Rheology modifier | 2.00% |
| 10 | Solvesso 200 ULN | Solvent | up to 100% |

### Example 7

| S. No. | Ingredient | Function | % W/W |
|---|---|---|---|
| 1 | Fluroxypyr-meptyl | Active Ingredient | 11.29% |
| 2 | Mefenpyr-diethyl | Safener | 2.35% |
| 3 | Thiencarbazone-methyl | Active Ingredient | 0.39% |
| 4 | Potassium carbonate | pH modifier | 0.13% |
| 5 | Soprophor BSU | Emulsifier | 1.13% |
| 6 | Nansa EVM 70/2E | Emulsifier | 5.50% |
| 7 | Methyl soyate | Oil adjuvant | 9.80% |
| 8 | Imbentin T/65 | Non-ionic Surfactant Adjuvant | 3.92% |
| 9 | Atplus UEP 100 | Non-ionic Surfactant Adjuvant | 7.84% |
| 10 | Aerosil R 812 S | Rheology modifier | 2.00% |
| 11 | Solvesso 200 ULN | Solvent | up to 100% |

### Process of Preparation for Examples 1 to 7

All oil-phase components were added together and mixed till homogenous, including Soprophor BSU, Nansa EVM 70/2E, Dispersogen PSL 100 or Atplus UEP 100/Imbentin T/150/Methylated soybean oil/Tween 20 and solvent. Then, Fluroxypyr-meptyl and Mefenpyr-diethyl were added and mixed until they were dissolved. Thiencarbazone-methyl and Potassium Carbonate were then added, and the mixture was grinded in a bead mill, till D (90) of below 10 μm was reached. Aerosil R 812 S was added to the mixture and the whole formulation was milled, until a stable oil dispersion was obtained.

The herbicidal composition for the weed control for the crop such as wheat is advantageous, for several purposes, e.g.:
allowing for a wider application window such as greater flexibility in the timing of application spanning over 1 to 50 days after sowing;
having synergistic effect being useful for addressing a broad weed spectrum;
requiring to be administered in lower dosage strength and lower dosage frequency;
offering a single solution with a wider application window.

The following test results illustrate the present invention and are not intended to limit the present invention.

Greenhouse experiments were conducted to evaluate the efficacy of the oil dispersion formulation of thiencarbazone-methyl and fluroxypyr-meptyl. The target crop was wheat and the targeted weeds were Amaranthus retroflexus and Setaria verticillata.

The weed seeds were placed in plastic pots (300 cm⁻³) filled with Neve Yaar soil (57% clay, 23% silt, and 20% sand, on a dry-weight basis, and 2% organic matter). Treatments were applied using a motorized laboratory sprayer equipped with an EvenSpray 8001E flat fan nozzle (Spraying Systems Co., Wheaton, IL, USA) delivering 200 L ha⁻¹ at 245 kPa. The plants were seeded and kept in a greenhouse throughout the experiment. The tested species and their growth status at application timing are listed in Table 1. The plant development status was scored through the experiment where 0- means complete plant death (control), and 100- means no injury symptoms (like control). 23 days or 21 days after treatment final control evaluations were held and it is listed in Table 2 and Table 3 respectively.

TABLE 1
The tested weed species and their growth stage.

| | | | Height | Leaves |
|---|---|---|---|---|
| BSC codes | Latin Name | Common Name | cm | No. |
| AVESA | Avena sativa | Cultured oats | 17-8 | 2-1 |
| TRZAX | Triticum aestivum | Common Wheat | 18-12 | 2 |
| AMARE | Amaranthus retroflexus | Pigweed | 4-2 | 3-2 |
| SETVE | Setaria verticillata | Bristlegrass | 5-3 | 2 |

TABLE 2
Pot trials results of 23 days after treatment:

| Active | Rate | Adjuvant | Avena | Triticum | Amaranthus | Setaria |
|---|---|---|---|---|---|---|
| Ingredient | ml du⁻¹ | rate | sativa | Aestivum | retroflexus | verticillata |
| Example 1 | 20 | | Minor-injury | No injury | Complete | High injury |
| | | | | | control | |
| Example 1 + | 20 + | 0.02% | Medium | No injury | Complete | High injury |
| Rhumba | 0.02% | | injury | | control | |
| | 20 + | 0.05% | Medium | No injury | Complete | High injury |
| | 0.05% | | injury | | control | |
| | 20 + | 0.25% | Medium | No injury | Complete | Very high |
| | 0.25% | | injury | | control | injury |
| | 20 + 1% | 1% | Medium | No injury | Complete | Very high |
| | | | injury | | control | injury |
| Example 1 + | 20 + 0.1% | 0.02% | Medium | No injury | Complete | High injury |
| Imbentin | | | injury | | control | |
| T/150 | 20 + | 0.05% | Medium high | No injury | Complete | Very high |
| | 0.25% | | injury | | control | injury |
| | 20 + | 0.25% | Medium high | No injury | Complete | Very high |
| | 1.25% | | injury | | control | injury |
| | 20 + 5% | 1% | Medium high | No injury | Complete | Very high |
| | | | injury | | control | injury |
| Example 1 + | 20 + | 0.02% | Very minor | No injury | Complete | Medium |
| ROME | 0.02% | | injury | | control | high injury |
| | 20 + | 0.05% | Minor | No injury | Complete | High injury |
| | 0.06% | | medium | | control | |
| | | | injury | | | |
| | 20 + | 0.25% | Medium high | No injury | Complete | Very high |
| | 0.28% | | injury | | control | injury |
| | 20 + 1.1% | 1% | Medium high | No injury | Complete | Very high |
| | | | injury | | control | injury |

Rhumba—85% methylated soybean oil (CAS 67784-80-9)
ROME—Methylated rapeseed oil
Imbentin T/150—Isotridecanol ethoxylated (15 EO)

TABLE 3
Pot trials results of 21 days after treatment:

| Active | Rate | Adjuvant | Avena | Triticum | Amaranthus | Setaria |
|---|---|---|---|---|---|---|
| Ingredient | ml du⁻¹ | rate | sativa | Aestivum | retroflexus | verticillata |
| Example 1 | 20 | | No injury | No injury | Very high | Medium |
| | | | | | injury | high injury |
| Example 1 + | 20 + | 0.05% | Very minor | No injury | Complete | Medium |
| Stepan C 65 | 0.06% | | injury | | control | high injury |
| | 20 + | 0.25% | Very minor | No injury | Complete | High injury |
| | 2.8% | | injury | | control | |
| Example 1 + | 20 + | 0.05% | No injury | No injury | Complete | High injury |
| Tween L- | 0.25% | | | | control | |
| 1010 | 20 + | 0.25% | Minor | No injury | Complete | High injury |
| | 1.25% | | medium | | control | |
| | | | injury | | | |
| Example 1 + | 20 + | 0.05% | Minor injury | No injury | Very high | High injury |
| Tween 20 | 0.25% | | | | injury | |
| | 20 + | 0.25% | Medium high | No injury | Complete | High injury |
| | 1.25% | | injury | | control | |
| Example 1 + | 20 + | 0.05% | Medium | No injury | Complete | Medium |
| Genamin O | 0.25% | | injury | | control | high injury |
| 200 | 20 + | 0.25% | Medium | No injury | Complete | High injury |
| | 1.25% | | injury | | control | |
| Example 1 + | 20 + | 0.05% | Minor | No injury | Complete | Medium |
| Lutensol XP | 0.25% | | medium | | control | high injury |
| 80 | | | injury | | | |
| | 20 + | 0.25% | Minor | No injury | Complete | High injury |
| | 1.25% | | medium | | control | |
| | | | injury | | | |
| Example 1 + | 20 + | 0.05% | Minor | No injury | Very high | Medium |
| Lmbentin | 0.25% | | medium | | injury | high injury |
| T/65 | | | injury | | | |
| | 20 + | 0.25% | Medium | No injury | Very high | High injury |
| | 1.25% | | injury | | injury | |
| Example 1 + | 20 + | 0.05% | Medium | No injury | Very high | High injury |
| Atplus UEP | 0.33% | | injury | | injury | |
| 100 | 20 + | 0.25% | Medium | No injury | Very high | High injury |
| | 1.67% | | injury | | injury | |
| Example 1 + | 20 + | 0.05% | Very minor | No injury | Very high | Medium |
| Atlox 4915 | 0.5% | | injury | | injury | high injury |
| | 20 + | 0.25% | Very minor | No injury | Very high | Medium |
| | 2.5% | | injury | | injury | high injury |
| Example 1 + | 20 + | 0.05% | Minor injury | No injury | Very high | Medium |
| Silwet HS | 0.25% | | | | injury | high injury |
| 312 | 20 + | 0.25% | Minor | No injury | Complete | Medium |
| | 1.25% | | medium | | control | high injury |
| | | | injury | | | |
| Example 1 + | 20 + | 0.05% | No injury | No injury | Very high | Medium |
| Altahance 3S | 0.06% | | | | injury | high injury |
| | 20 + | 0.25% | Very minor | No injury | Very high | Medium |
| | 0.28% | | injury | | injury | high injury |

### Control Index:

%100—No injury (like control)
90-95%—Very minor injury
80-85%—Minor injury
65-75%—Minor medium injury
50-60%—Medium injury
35-45%—Medium high injury
20-30%—High injury
5-15%—Very high injury
0%—Complete control

Results: Oil dispersion formulation of thiencarbazone-methyl, fluroxypyr-meptyl, mefenpyr-diethyl and adjuvant show good effect on the control of weeds Amaranthus retroflexus and Setaria verticillata.

Thus, it has been observed that the compositions of the present invention, demonstrate enhanced, efficacious and superior behaviour in the field. In fact, various advantageous properties associated with the compositions according to the invention, include but are not limited to improved stability, improved crop characteristics including crop yields, disease resistance and other advantages familiar to a person skilled in the art.

Thus, from the foregoing description, it will be apparent to people skilled in the art that many changes and modifications can be made without departing from the spirit or scope of the invention as set forth in the description. Accordingly, it is not intended that the scope of the foregoing description be limited to the description set forth above, but rather that such description be construed as encompassing such features that reside in the present invention, including all the features and embodiments that would be treated as equivalents thereof by those skilled in the relevant art.

We claim:

1. An herbicidal composition comprising thiencarbazone-methyl, fluroxypyr-meptyl, a safener, an inert system and agrochemically acceptable carriers;
wherein
thiencarbazone-methyl is present in an amount of 0.25 to 1.50% w/w;
fluroxypyr-meptyl is present in amount of 7.2 to 38% w/w;
safener is present in an amount of 1.5 to 9% w/w and
the inert system comprises at least a surfactant, an adjuvant or a combination thereof.

2. The herbicidal composition as claimed in claim 1, wherein the composition is a non-aqueous composition selected from the group comprising an oil dispersion formulation and an emulsifiable concentrate formulation.

3. The herbicidal composition as claimed in claim 1, wherein the safener is selected from the group comprising benoxacor, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, metcamifen, mefenpyr, mephenate, naphthalic anhydride, R-29148, AD-67, oxabetrinil or esters thereof.

4. The herbicidal composition as claimed in claim 3, wherein the safener is selected from the group comprising mefenpyr-diethyl, cloquintocet-mexyl, or fenchlorazole-ethyl.

5. The herbicidal composition as claimed in claim 1, wherein the thiencarbazone-methyl and fluroxypyr-meptyl in a ratio of 1:50 to 1:5.

6. The herbicidal composition as claimed in claim 5, wherein the thiencarbazone-methyl and fluroxypyr-meptyl in a ratio of 1:30 to 1:10.

7. The herbicidal composition as claimed in claim 1, wherein the agrochemically acceptable carriers are selected from the group comprising solvent, rheology modifier, pH modifier or a combination thereof.

8. The herbicidal composition as claimed in claim 1, wherein the surfactant is selected from the group comprising anionic surfactant, non-ionic surfactant, amphoteric surfactant, polymeric surfactant or a combination thereof and it is present in an amount of 0.1 to 20% w/w.

9. The herbicidal composition as claimed in claim 8, wherein the surfactant is selected from the group comprising polyethylene glycol, tristyryphenol, polyalkylene glycol ether, polyoxyethylene sorbitan monooleate, alcohol polyglycol ether, dodecylbenzene sulfonate calcium salt, oleyl alcohol, tristyrylphenol ethoxylate phosphate ester, sodium dioctyl sulfosuccinate, polyacrylate or a combination thereof.

10. The herbicidal composition as claimed in claim 1, wherein the adjuvant is selected from the group comprising a non-ionic surfactant, an oil-based adjuvant, or a combination thereof and it is present in an amount of 0.01 to 30%.

11. The herbicidal composition as claimed in claim 10, wherein the adjuvant is selected from the group comprising alcohol ethoxylate; sorbitan ester ethoxylate, alkoxylated polyol ester, polyethoxylated amine, vegetable oil, C₁-C₆ mono-esters derived from vegetable oil, mineral oil, or a combination thereof.

12. The herbicidal composition as claimed in claim 11, wherein alcohol ethoxylate comprises Imbentin T/150, Imbentin T/120, Imbentin T/65; sorbitan ester ethoxylate comprises Tween 20; alkoxylated polyol ester comprises Atplus UEP 100; polyethoxylated amine comprises Genamin O 200; vegetable oil; mineral oil comprises white mineral oil; C₁-C₆ mono-esters derived from vegetable oil comprises methyl soyate or a combination thereof.

13. The herbicidal composition as claimed in claim 11, wherein the adjuvant is selected from the group consisting of alcohol ethoxylate, sorbitan ester ethoxylate, C₁-C₆ mono-esters derived from vegetable oil and combination thereof.

14. The herbicidal composition as claimed in claim 13, wherein the adjuvant is selected from the group consisting of Imbentin T/65, Atplus UEP 100, methyl soyate and combination thereof.

15. The herbicidal composition as claimed in claim 1, wherein the adjuvant is a built-in adjuvant.

16. The herbicidal composition as claimed in claim 7, wherein the solvent is selected from the group comprising aromatic and non-aromatic hydrocarbons, mixture of aromatic and non-aromatic hydrocarbon, halogenated aromatic and non-aromatic hydrocarbons, petroleum distillates, aromatic and non-aromatic ethers, esters, amides, mineral oil, petroleum oil, vegetable oil, animal oil or mixtures thereof and it is present in an amount of 30 to 80% w/w.

17. The herbicidal composition as claimed in claim 7, wherein the rheology modifier is selected from the group comprising modified natural silicate, synthetic silicate, natural polymer, synthetic polymer, natural oil, starch derivative or polysaccharide, inorganic fine powder or a combination thereof and it is present in an amount of 0.5 to 5% w/w.

18. The herbicidal composition as claimed in claim 7, wherein the pH modifier is selected from the group comprising sodium or potassium carbonate, sodium or potassium hydrogen carbonate, sodium or potassium dihydrogenphosphate, disodium or dipotassium hydrogenphosphate, citric acid, malic acid, lauric acid, oleic acid triethanolamine or a combination thereof and it is present in an amount of 0.01 to 5.00% w/w.

19. The herbicidal composition comprising adjuvant as claimed in claim 1 to 18 for controlling the broad leaved weeds or grass weeds, wherein the adjuvant present in the composition is effective at increasing effectiveness or efficacy of the herbicidal composition.

20. The herbicidal composition comprising adjuvant as claimed in claim 19, wherein the adjuvant is selected from the group comprising a non-ionic surfactant, an oil-based adjuvant or a combination thereof and it is present in an amount of 0.01 to 30%.

21. The herbicidal composition comprising adjuvant as claimed in claim 20, wherein the adjuvant is selected from the group comprising alcohol ethoxylate; sorbitan ester ethoxylate, alkoxylated polyol ester, polyethoxylated amine, vegetable oil, C₁-C₆ mono-esters derived from vegetable oil, mineral oil, or a combination thereof.

22. The herbicidal composition comprising adjuvant as claimed in claim 21, wherein alcohol ethoxylate comprises Imbentin T/150, Imbentin T/120, Imbentin T/65; sorbitan ester ethoxylate comprises Tween 20; alkoxylated polyol ester comprises Atplus UEP 100; polyethoxylated amine comprises Genamin O 200; vegetable oil comprises soybean methylated oil; mineral oil comprises white mineral oil; C₁-C₆ mono-esters derived from vegetable oil comprises methyl soyate or a combination thereof.

23. The herbicidal composition comprising adjuvant as claimed in claim 21, wherein the adjuvant is selected from the group consisting of alcohol ethoxylate, sorbitan ester ethoxylate, C₁-C₆ mono-esters derived from vegetable oil and combination thereof.

24. The herbicidal composition comprising adjuvant as claimed in claim 23, wherein the adjuvant is selected from the group consisting of Imbentin T/65, Atplus UEP 100, methyl soyate and combination thereof.

25. The herbicidal composition comprising adjuvant as claimed in claim 19 for controlling broad leaved weeds or grass weeds, wherein the weeds are selected from a group comprising Aventa fatua, Bassia scoparia, Setaria verticillata, Setaria viridis, Echinochloa crus-galli, Setaria pumila, Lolium persicum, Galium aparine L., Malva rotundifolia, Linum usitatissimum, Volunteer canary, Stellaria media, Galeopsis tetrahit L., Erodium cicutarium, Fagopyrum esculentum, Bromus japonicus, Sinapis arvensis, Ailanthus altissima, Capsella bursa-pastoris, Volunteer canola, Persicaria lapathifolia, Fagopyrum esculentum, Chenopodium album, Salsola tragus, Malva pusilla and Amaranthus retroflexus.

26. The herbicidal composition as claimed in claim 19 for controlling broad leaved weeds or grass weeds, wherein the weeds are selected from the group comprising Aventa fatua, Bassia scoparia, Setaria verticillata and Amaranthus retroflexus.
